(19) United States
(12) Patent Application Publication
(10) Pub. No.: US 2025/0374187 A1
(43) Pub. Date: Dec. 4, 2025

(54) USER EQUIPMENT LIFE CYCLE MANAGEMENT DURING DISCONTINUOUS RECEPTION

(71) Applicant: NOKIA TECHNOLOGIES OY, ESPOO (FI)

(72) Inventors: Jian SONG, Palaiseau (FR); Afef FEKI, Sceaux (FR); Ahmad MASRI, Tampere (FI); Sakira HASSAN, Espoo (FI); Fahad SYED MUHAMMAD, Orsay (FI)

(21) Appl. No.: 18/680,502

(22) Filed: May 31, 2024

(51) Int. Cl. H04W 52/02; H04W 76/28

(52) U.S. Cl. CPC H04W 52/0235; H04W 52/0216; H04W 76/28

(57) ABSTRACT

Systems, methods, apparatuses, and computer program products for periodic data collection for LCM functions and LCM signaling to allow UE to perform model-based and/or functionality-based LCM. One method may include a UE transmitting, to a network entity, at least one discontinuous reception, DRX, and life cycle management, LCM, monitoring configuration signaling request; receiving, in response to the at least one DRX and LCM monitoring configuration signaling request, at least one DRX and LCM monitoring configuration signaling response from the network entity; prioritizing, based on the at least one DRX and LCM monitoring configuration signaling response, at least one of a DRX functionality or a machine learning, ML, functionality; and transmitting, to the network entity, a DRX and LCM monitoring status report.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for periodic data collection for life cycle management (LCM) functions and LCM signaling to allow user equipment (UE) to perform model-based LCM.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, from a UE to a network entity, at least one DRX and LCM monitoring configuration signaling request. The method may further include receiving, by the UE, in response to the at least one DRX and LCM monitoring configuration signaling request, at least one DRX and LCM monitoring configuration signaling response from the network entity. The method may further include prioritizing, by the UE, based on the at least one DRX and LCM monitoring configuration signaling response, at least one of a DRX functionality or a machine learning, ML, functionality. The method may further include transmitting, from the UE to the network entity, a DRX and LCM monitoring action request, wherein the action request comprises a condition verification outcome report. The method may further include receiving, by the UE, a DRX and LCM monitoring action acknowledgement from the network entity.

In accordance with certain example embodiments, an apparatus may include means for transmitting, to a network entity, at least one DRX and LCM monitoring configuration signaling request. The apparatus may further include means for receiving, in response to the at least one DRX and LCM monitoring configuration signaling request, at least one DRX and LCM monitoring configuration signaling response from the network entity. The apparatus may further include means for prioritizing, based on the at least one DRX and LCM monitoring configuration signaling response, at least one of a DRX functionality or a machine learning, ML, functionality. The apparatus may further include means for transmitting, to the network entity, a DRX and LCM monitoring action request, wherein the action request comprises a condition verification outcome report. The apparatus may further means for receiving a DRX and LCM monitoring action acknowledgement from the network entity.

In accordance with various example embodiments, a non-transitory computer readable medium may include program instructions that, when executed by an apparatus, cause the apparatus to perform at least a method. The method may include transmitting, to a network entity, at least one DRX and LCM monitoring configuration signaling request. The method may further include receiving, in response to the at least one DRX and LCM monitoring configuration signaling request, at least one DRX and LCM monitoring configuration signaling response from the network entity. The method may further include prioritizing, based on the at least one DRX and LCM monitoring configuration signaling response, at least one of a DRX functionality or a machine learning, ML, functionality. The method may further include transmitting, to the network entity, a DRX and LCM monitoring action request, wherein the action request comprises a condition verification outcome report. The method may further include receiving a DRX and LCM monitoring action acknowledgement from the network entity.

In accordance with some example embodiments, a computer program product may perform a method. The method may include transmitting, to a network entity, at least one DRX and LCM monitoring configuration signaling request. The method may further include receiving, in response to the at least one DRX and LCM monitoring configuration signaling request, at least one DRX and LCM monitoring configuration signaling response from the network entity. The method may further include prioritizing, based on the at least one DRX and LCM monitoring configuration signaling response, at least one of a DRX functionality or a machine learning, ML, functionality. The method may further include transmitting, to the network entity, a DRX and LCM monitoring action request, wherein the action request comprises a condition verification outcome report. The method may further include receiving a DRX and LCM monitoring action acknowledgement from the network entity.

In accordance with certain example embodiments, an apparatus may include at least one processor and at least one memory storing instructions that, when executed by the at least one processor, cause the apparatus at least to transmit, to a network entity, at least one DRX and LCM monitoring configuration signaling request. The at least one memory and instructions, when executed by the at least one processor, may further cause the apparatus at least to receive, in response to the at least one DRX and LCM monitoring configuration signaling request, at least one DRX and LCM monitoring configuration signaling response from the network entity. The at least one memory and instructions, when executed by the at least one processor, may further cause the apparatus at least to prioritize, based on the at least one DRX and LCM monitoring configuration signaling response, at least one of a DRX functionality or a machine learning, ML, functionality. The at least one memory and instructions, when executed by the at least one processor, may further cause the apparatus at least to transmit, to the network entity, a DRX and LCM monitoring action request, wherein the action request comprises a condition verification outcome report. The at least one memory and instructions, when executed by the at least one processor, may further cause the apparatus at least to receive a DRX and LCM monitoring action acknowledgement from the network entity.

In accordance with various example embodiments, an apparatus may include transmitting circuitry configured to perform transmitting, to a network entity, at least one DRX and LCM monitoring configuration signaling request. The apparatus may further include receiving circuitry configured to perform receiving, in response to the at least one DRX and LCM monitoring configuration signaling request, at least one DRX and LCM monitoring configuration signaling response from the network entity. The apparatus may further include prioritizing circuitry configured to perform prioritizing, based on the at least one DRX and LCM monitoring configuration signaling response, at least one of a DRX functionality or a machine learning, ML, functionality. The apparatus may further include transmitting circuitry configured to perform transmitting, to the network entity, a DRX and LCM monitoring action request, wherein the action request comprises a condition verification outcome report. The apparatus may further include receiving circuitry configured to perform receiving a DRX and LCM monitoring action acknowledgement from the network entity.

In accordance with some example embodiments, a method may include receiving, by a network entity from a UE, at least one DRX and LCM monitoring configuration signaling request. The method may further include transmitting, by the network entity to the UE, in response to the at least one DRX and LCM monitoring configuration signaling request, at least one DRX and LCM monitoring configuration signaling response. The method may further include receiving, by the network entity from the UE, a DRX and LCM monitoring action request, wherein the action request comprises a condition verification outcome report. The method may further include transmitting, by the network entity to the UE, a DRX and LCM monitoring action acknowledgement.

In accordance with certain example embodiments, an apparatus may include means for receiving, from a UE, at least one DRX and LCM monitoring configuration signaling request. The apparatus may further include means for transmitting, to the UE, in response to the at least one DRX and LCM monitoring configuration signaling request, at least one DRX and LCM monitoring configuration signaling response. The apparatus may further include means for receiving, from the UE, a DRX and LCM monitoring action request, wherein the action request comprises a condition verification outcome report. The apparatus may further include means for transmitting, to the UE, a DRX and LCM monitoring action acknowledgement.

In accordance with various example embodiments, a non-transitory computer readable medium may include program instructions that, when executed by an apparatus, cause the apparatus to perform at least a method. The method may include receiving, from a UE, at least one DRX and LCM monitoring configuration signaling request. The method may further include transmitting, to the UE, in response to the at least one DRX and LCM monitoring configuration signaling request, at least one DRX and LCM monitoring configuration signaling response. The method may further include receiving, from the UE, a DRX and LCM monitoring action request, wherein the action request comprises a condition verification outcome report. The method may further include transmitting, to the UE, a DRX and LCM monitoring action acknowledgement.

In accordance with some example embodiments, a computer program product may perform a method. The method may include receiving, from a UE, at least one DRX and LCM monitoring configuration signaling request. The method may further include transmitting, to the UE, in response to the at least one DRX and LCM monitoring configuration signaling request, at least one DRX and LCM monitoring configuration signaling response. The method may further include receiving, from the UE, a DRX and LCM monitoring action request, wherein the action request comprises a condition verification outcome report. The method may further include transmitting, to the UE, a DRX and LCM monitoring action acknowledgement.

In accordance with certain example embodiments, an apparatus may include at least one processor and at least one memory storing instructions that, when executed by the at least one processor, cause the apparatus at least to receive, from a UE, at least one DRX and LCM monitoring configuration signaling request. The at least one memory and instructions, when executed by the at least one processor, may further cause the apparatus at least to transmit, to the UE, in response to the at least one DRX and LCM monitoring configuration signaling request, at least one DRX and LCM monitoring configuration signaling response. The at least one memory and instructions, when executed by the at least one processor, may further cause the apparatus at least to receive, from the UE, a DRX and LCM monitoring action request, wherein the action request comprises a condition verification outcome report. The at least one memory and instructions, when executed by the at least one processor, may further cause the apparatus at least to transmit, to the UE, a DRX and LCM monitoring action acknowledgement.

In accordance with various example embodiments, an apparatus may include receiving circuitry configured to perform receiving, from a UE, at least one DRX and LCM monitoring configuration signaling request. The apparatus may further include transmitting circuitry configured to perform transmitting, to the UE, in response to the at least one DRX and LCM monitoring configuration signaling request, at least one DRX and LCM monitoring configuration signaling response. The apparatus may further include receiving circuitry configured to perform receiving, from the UE, a DRX and LCM monitoring action request, wherein the action request comprises a condition verification outcome report. The apparatus may further include transmitting circuitry configured to perform transmitting, to the UE, a DRX and LCM monitoring action acknowledgement.

In accordance with some example embodiments, a method may include transmitting, from a UE to a network entity, at least one DRX and LCM monitoring configuration signaling request. The method may further include receiving, by the UE, in response to the at least one DRX and LCM monitoring configuration signaling request, at least one DRX and LCM monitoring configuration signaling response from the network entity. The method may further include prioritizing, by the UE, based on the at least one DRX and LCM monitoring configuration signaling response, at least one of a DRX functionality or a machine learning, ML, functionality. The method may further include transmitting, from the UE to the network entity, a DRX and LCM monitoring status report.

In accordance with certain example embodiments, an apparatus may include means for transmitting, to a network entity, at least one DRX and LCM monitoring configuration signaling request. The apparatus may further include means for receiving, in response to the at least one DRX and LCM monitoring configuration signaling request, at least one DRX and LCM monitoring configuration signaling response from the network entity. The apparatus may further include means for prioritizing, based on the at least one DRX and LCM monitoring configuration signaling response, at least one of a DRX functionality or a machine learning, ML, functionality. The apparatus may further include means for transmitting, to the network entity, a DRX and LCM monitoring status report.

In accordance with various example embodiments, a non-transitory computer readable medium may include program instructions that, when executed by an apparatus, cause the apparatus to perform at least a method. The method may include transmitting, to a network entity, at least one DRX and LCM monitoring configuration signaling request. The method may further include receiving, in response to the at least one DRX and LCM monitoring configuration signaling request, at least one DRX and LCM monitoring configuration signaling response from the network entity. The method may further include prioritizing, based on the at least one DRX and LCM monitoring configuration signaling response, at least one of a DRX functionality or a machine learning, ML, functionality. The method may further include transmitting, to the network entity, a DRX and LCM monitoring status report.

In accordance with some example embodiments, a computer program product may perform a method. The method may include transmitting, to a network entity, at least one DRX and LCM monitoring configuration signaling request. The method may further include receiving, in response to the at least one DRX and LCM monitoring configuration signaling request, at least one DRX and LCM monitoring configuration signaling response from the network entity. The method may further include prioritizing, based on the at least one DRX and LCM monitoring configuration signaling response, at least one of a DRX functionality or a machine learning, ML, functionality. The method may further include transmitting, to the network entity, a DRX and LCM monitoring status report.

In accordance with certain example embodiments, an apparatus may include at least one processor and at least one memory storing instructions that, when executed by the at least one processor, cause the apparatus at least to transmit, to a network entity, at least one DRX and LCM monitoring configuration signaling request. The at least one memory and instructions, when executed by the at least one processor, may further cause the apparatus at least to receive, in response to the at least one DRX and LCM monitoring configuration signaling request, at least one DRX and LCM monitoring configuration signaling response from the network entity. The at least one memory and instructions, when executed by the at least one processor, may further cause the apparatus at least to prioritize, based on the at least one DRX and LCM monitoring configuration signaling response, at least one of a DRX functionality or a machine learning, ML, functionality. The at least one memory and instructions, when executed by the at least one processor, may further cause the apparatus at least to transmit, to the network entity, a DRX and LCM monitoring status report.

In accordance with various example embodiments, an apparatus may include transmitting circuitry configured to perform transmitting, to a network entity, at least one DRX and LCM monitoring configuration signaling request. The apparatus may further include receiving circuitry configured to perform receiving, in response to the at least one DRX and LCM monitoring configuration signaling request, at least one DRX and LCM monitoring configuration signaling response from the network entity. The apparatus may further include prioritizing circuitry configured to perform prioritizing, based on the at least one DRX and LCM monitoring configuration signaling response, at least one of a DRX functionality or a machine learning, ML, functionality. The apparatus may further include transmitting circuitry configured to perform transmitting, to the network entity, a DRX and LCM monitoring status report.

In accordance with some example embodiments, a method may include receiving, by a network entity from a UE, at least one DRX and LCM monitoring configuration signaling request. The method may further include transmitting, by the network entity to the UE, in response to the at least one DRX and LCM monitoring configuration signaling request, at least one DRX and LCM monitoring configuration signaling response. The method may further include receiving, by the network entity from the UE, a DRX and LCM monitoring status report.

In accordance with certain example embodiments, an apparatus may include means for receiving, from a UE, at least one DRX and LCM monitoring configuration signaling request. The apparatus may further include means for transmitting, to the UE, in response to the at least one DRX and LCM monitoring configuration signaling request, at least one DRX and LCM monitoring configuration signaling response. The apparatus may further include means for receiving, from the UE, a DRX and LCM monitoring status report.

In accordance with various example embodiments, a non-transitory computer readable medium may include program instructions that, when executed by an apparatus, cause the apparatus to perform at least a method. The method may include receiving, from a UE, at least one DRX and LCM monitoring configuration signaling request. The method may further include transmitting, to the UE, in response to the at least one DRX and LCM monitoring configuration signaling request, at least one DRX and LCM monitoring configuration signaling response. The method may further include receiving, from the UE, a DRX and LCM monitoring status report.

In accordance with some example embodiments, a computer program product may perform a method. The method may include receiving, from a UE, at least one DRX and LCM monitoring configuration signaling request. The method may further include transmitting, to the UE, in response to the at least one DRX and LCM monitoring configuration signaling request, at least one DRX and LCM monitoring configuration signaling response. The method may further include receiving, from the UE, a DRX and LCM monitoring status report.

In accordance with certain example embodiments, an apparatus may include at least one processor and at least one memory storing instructions that, when executed by the at least one processor, cause the apparatus at least to receive, from a UE, at least one DRX and LCM monitoring configuration signaling request. The at least one memory and instructions, when executed by the at least one processor, may further cause the apparatus at least to transmit, to the UE, in response to the at least one DRX and LCM monitoring configuration signaling request, at least one DRX and LCM monitoring configuration signaling response. The at least one memory and instructions, when executed by the at least one processor, may further cause the apparatus at least to receive, from the UE, a DRX and LCM monitoring status report.

In accordance with various example embodiments, an apparatus may include receiving circuitry configured to perform receiving, from a UE, at least one DRX and LCM monitoring configuration signaling request. The apparatus may further include transmitting circuitry configured to perform transmitting, to the UE, in response to the at least one DRX and LCM monitoring configuration signaling request, at least one DRX and LCM monitoring configuration signaling response. The apparatus may further include receiving circuitry configured to perform receiving, from the UE, a DRX and LCM monitoring status report.

### BRIEF DESCRIPTION OF THE DRAWINGS

For a proper understanding of example embodiments, reference should be made to the accompanying drawings, wherein:

FIG. 1 illustrates an example of UE discontinuous reception cycle in connected mode;

FIG. 2 illustrates discontinuous reception and machine learning life cycle collision conditions in time domain;

FIG. 3 illustrates an example of UE prioritizing power savings and discontinuous reception according to certain example embodiments;

FIG. 4 illustrates an example of UE prioritizing machine learning functionalities and LCM according to some example embodiments;

FIG. 5 illustrates another example of UE prioritizing machine learning functionalities and LCM according to various example embodiments;

FIG. 6 illustrates an example of a signaling diagram for a network-centric procedure according to certain example embodiments;

FIG. 7 illustrates an example of a signaling diagram for a UE-centric procedure according to certain example embodiments;

FIG. 8 illustrates some various additional example embodiments when discontinuous reception cycle is shorter than machine learning life cycle;

FIG. 9 illustrates a summary of overlapping cases between discontinuous reception cycle versus machine learning life cycle;

FIG. 10 illustrates an example of a flow diagram of a method according to certain example embodiments;

FIG. 11 illustrates an example of a flow diagram of a method according to some example embodiments;

FIG. 12 illustrates an example of a flow diagram of a method according to various example embodiments;

FIG. 13 illustrates an example of a flow diagram of a method according to certain example embodiments;

FIG. 14 illustrates an example of various network devices according to some example embodiments; and

FIG. 15 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for periodic data collection for LCM functions and LCM signaling to allow UE to perform model-based LCM is not intended to limit the scope of certain example embodiments, but is instead representative of selected example embodiments.

Plenary 3GPP RAN may include artificial intelligence (AI)/machine learning (ML) mobility and LCM studied in Rel 18 AI/ML NR air interface. Two different types of LCM have been considered at the UE side: functionality-based LCM and model-identifier (ID) based LCM. In functionality-based LCM, models may be identified, and the network (NW) may indicate LCM signaling (e.g., activation/deactivation/fallback/switching) of AI/ML functionality via 3GPP signaling. If models are not identified, the UE may perform model-level LCM. In contrast, models in model-ID based LCM may be identified at the NW, and the NW and/or UE may activate/deactivate/select/switch individual AI/ML models via model IDs. Other LCM function related models may include training, monitoring, updating, fine tuning, and validating. LCM functions may require data, and LCM signaling may be considered based on the monitoring decision. Therefore, a UE may need to perform data collection for LCM functions. The data may need to be logged, and periodicity of the data collection process can vary depending on the purposes. The periodicity can be categorized as periodic, semi-persistence, aperiodic, and event triggered.

The periodicity of the data collection and training, inference, and monitoring may be affected by LCM signaling. Thus, data collection procedures for LCM functions may disrupt the existing periodicity and start a new cycle. Moreover, during a particular LCM signaling (e.g., selection procedure), there may be several discontinuous reception (DRX) cycles, where each DRX cycle corresponds to different functionality or model. Additionally, the latency of each LCM signaling and data collection triggering could affect DRX cycle.

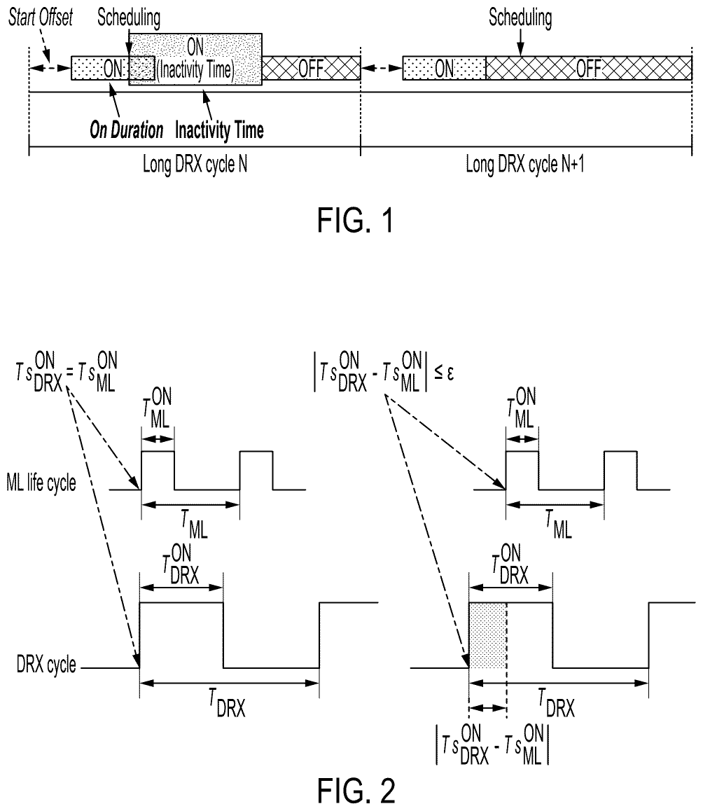

FIG. 1 shows the high-level functional diagram of a UE DRX cycle, which is a power-saving feature used in LTE and NR networks to reduce power consumption in UE by periodically turning off radio functionalities when there is no data to be transmitted or received. With DRX, a UE may inform the network that it is going to sleep for a certain period of time, during which the network will buffer any outgoing data until the UE exits DRX (i.e., wakes up).

There are several types of DRX modes, including idle mode and connected mode. In DRX idle mode, the UE may periodically wake up to check for paging messages from the network, while in connected mode, the UE may enter a DRX sleep mode while waiting to receive data transmitted by the network.

DRX can significantly extend the battery life of UE, especially in applications where the data traffic is intermittent (e.g., voice calls, messaging applications). However, DRX may also introduce delays in data transmission, as the network may buffer data until the UE wakes up, which may be unsuitable for applications that require real-time data transmission (e.g., video streaming, online gaming).

To extend UE's battery life, a RRC connected UE may be configured with a connected mode DRX cycle (C-DRX). The configuration of C-DRX cycle is an RRC task, and may be controlled by a variety of parameters, such as:
drx-onDurationTimer: the duration at the beginning of a DRX cycle;
drx-SlotOffset: the delay before starting drx-onDurationTimer;
drx-InactivityTimer: the duration after a physical downlink control channel (PDCCH) occasion in which a PDCCH indicates a new uplink (UL) or downlink (DL) transmission for the medium access control (MAC) entity;
drx-RetransmissionTimerDL (per DL hybrid automatic repeat request (HARQ) process except for the broadcast process): the maximum duration until a DL retransmission is received;
drx-RetransmissionTimerUL (per UL HARQ process): the maximum duration until a grant for UL retransmission is received;
drx-LongCycleStartOffset: the long DRX cycle and drx-StartOffset which defines the subframe where the long and short DRX cycle starts;
drx-ShortCycle: the short DRX cycle;
drx-ShortCycleTimer: the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup: the configuration to start associated drx-onDurationTimer in case downlink control information (DCI) with cyclic redundancy check (CRC) scrambled by power saving-radio network temporary identifier (PS-RNTI) is monitored but not detected;
ps-TransmitOtherPeriodicCSI: the configuration to report periodic channel state information (CSI) that is not layer 1 (L1)-reference signal received power (RSRP) on physical uplink control channel (PUCCH) during the time duration indicated by drx-onDurationTimer in case DCP is configured but associated drx-onDurationTimer is not started;
ps-TransmitPeriodicL1-RSRP: the configuration to transmit periodic CSI that is L1-RSRP on PUCCH during the time duration indicated by drx-onDurationTimer in case DCP is configured but associated drx-onDurationTimer is not started;

When DRX for a UE is configured, a MAC entity may perform various functions; if a DRX Command MAC control element (CE) or a Long DRX Command MAC CE is received, the MAC entity may stop drx-onDurationTimer and drx-InactivityTimer for each DRX group. If the Short DRX cycle is used for a DRX group, and [(system frame number (SFN)×10)+subframe number] modulo (drx-ShortCycle) =(drx-StartOffset) modulo (drx-ShortCycle), the MAC entity may start drx-onDurationTimer for this DRX group after drx-SlotOffset from the beginning of the subframe. If the Long DRX cycle is used for a DRX group, and [(SFN×10)+subframe number] modulo (drx-LongCycle)=drx-StartOffset.

3GPP Rel-19 studies on AI/ML for mobility in NR (FS_NR_AIML_Mob) will focus on mobility enhancements in RRC_CONNECTED mode over air interface by following existing mobility frameworks (i.e., handover decision is always made in network side). Mobility use cases focus on standalone NR primary cell (PCell) change. UE-side and network-side AI/ML models can be both considered, respectively.

AI/ML for mobility in NR may provide benefits and gains of AI/ML aided mobility for network triggered L3-based handover. For example, AI/ML based RRM measurements and event predictions may include cell-level measurement predictions, including intra and inter-frequency (UE sided and NW sided model) (e.g., Inter-cell Beam-level measurement prediction for L3 Mobility (UE sided and NW sided model)); handover (HO) failure/radio link failure (RLF) prediction (UE sided model); and measurement events prediction (UE sided model). The evaluation of the AI/ML aided mobility benefits may consider HO performance key performance indicators (KPIs) (e.g., ping-pong HO, handover failure (HOF)/RLF, time of stay, handover interruption, prediction accuracy, and measurement reduction) and complexity tradeoffs. Potential AI mobility specific enhancements may be based on the 3GP Rel-19 AI/ML-air interface work item description (WID) general framework (e.g., LCM, performance monitoring etc.).

In the context of 3GPP Rel-19, UE RRM measurements may be important input data for various ML models designed to predict mobility-related events. However, the activation of DRX may pose challenges; the off durations in DRX may significantly impact the data collection process for measurements, thereby influencing the predictive accuracy of these models (e.g., after training with collected data). Typically, ML models deployed on the UE side may undergo a specific life cycle encompassing phases like training, inference, and monitoring within the time domain. It would be beneficial to design a coherent mechanism that integrates the impact of the DRX cycle with UE LCM, especially in the context of AI/ML-enabled mobility enhancements. This integration is pivotal to ensuring the efficacy and reliability of ML applications in dynamic network environments.

A UE may perform LCM operations (e.g., inference, training), and may collect data for these LCM operations (e.g., positioning accuracy enhancement, beam management to list 3GPP RAN1 Rel-18 confirmed AI/ML cases). Therefore, data collection and LCM procedures may be executed at the UE side to ensure efficient operation of AI/ML functionalities. In addition, to minimize power consumed by the UE, DRX mode may be enabled and configured by the network.

This, however, may raise some challenges. For example, for both DRX and AI/ML LCM procedures at the UE, when DRX is enabled at the UE side, it may be unknown how this would affect the ML LCM procedure in terms of data collection. To ensure different data collection procedures (e.g., training, monitoring, and/or inference), some critical data (e.g., radio measurements) may be required for some situations. However, during the off period when DRX is activated, these measurements are not performed and reported, which may affect the LCM procedures. Current techniques do not address the signaling impact to handle these measurement reporting changes.

In addition, when DRX is enabled at the UE side, there is no definition of how this would affect the ML LCM procedure in terms of LCM procedures (e.g., performance monitoring). In particular, the ON duration period when the DRX is enabled may be limited, and the UE may be incapable of all the actions as before (when always ON). Therefore, when DRX cycle collides with AI/ML LCM procedures (e.g., training, monitoring, updating, inferring), the UE may determine what to prioritize, and, if needed, to update DRX decision.

To simultaneously handle DRX and LCM procedures at UE, prioritization policies and condition to adapt both cycles would be beneficial, for both DRX running at the UE, as well as ML functionality running at the UE, assisted by NW, and related LCM function constraints. For DRX particularly, DRX parameters (e.g., On/Off period) may be pre-selected and rarely updated. During Off periods, the UE may not perform and report measurements; thus, data collection may be disabled during these durations. If the UE receives an urgent request to switch to On, a WUS may be employed; however, it may not be immediate, and some delay may be expected to wake up the UE.

For ML functionality LCM, different functional part of LCM may be executed, with each functional part having its own constraints. Specifically, for model training, data collection may be used to collect ground truth or labelled data; therefore, DRX may delay this operation, and subsequently, delay training the model. During inferences, data collection may be used to obtain input data to perform predictions; thus, depending on the situation, the delay for inference output may be considered a constraint. During performance monitoring, data collection may allow for tracking the performance of the ML model run by the UE. Thus, a delay to obtain the data may delay the detection of the considered model degradation (which may affect model monitoring), the extent of which depending on the situation.

Certain example embodiments described herein may have various benefits and/or advantages to overcome the disadvantages described above. For example, certain example embodiments may improve efficiency between DRX and LCM procedures by the UE, conserve energy by enabling DRX functionalities, and account for different LCM functionalities handled by the UE. Thus, certain example embodiments discussed below are directed to improvements in computer-related technology.

Some example embodiments discussed herein may relate to periodic data collection for LCM functions and LCM signaling to allow UE to perform model-based LCM, including implementation of prioritization policies configured for simultaneously DRX and LCM cycles. For example, certain example embodiments may include RRC configuration parameters that may account for the evaluation criteria and constraints so that the UE can perform the assessment of prioritization of DRX and power saving or ML functionalities at the UE. Such RRC configuration parameters could include any of time collision conditions between DRX cycle and ML life cycle and related parameters; condition to prioritize power saving and parameters; and condition to prioritize ML functionalities and parameters. Generally, the UE is the host entity that enables and performs ML based LCM functionalities (e.g., data collection, training and inference, monitoring, etc.). LCM procedures and DRX cycles may also be synchronized at the beginning of each active time.

Some example embodiments may be NW-centric, wherein RRC and L1/L2 signaling procedures and exchanged control messages between the NE and UE may be improved to dynamically skip the ML life cycle for UE power saving and/or prioritize the ML life cycle for the desired use case.

Additional or alternatively, various example embodiments may be UE-centric, wherein UE behavior may be based on RRC parameters and additional conditions that enable the UE to autonomously determine (i.e., without additional signaling between the network and UE) that the monitoring action for DRX or ML life cycle can be taken.

Certain example embodiments may include a UE DRX and ML LCM monitoring mechanism at a MAC entity for the UE and NE to monitor when DRX collides with ML life cycle when the monitoring conditions are satisfied. For example, if UE DRX and ML LCM monitoring mechanism is configured, the MAC entity may determine that the DRX cycle collides with the ML life cycle in time domain (either in ms or SFN) or overlapping in time, ε (ms or SFN).

The DRX and ML life cycle collision conditions may be verified in time domain (ms, SFN, etc.). In one example (i.e., synchronized case), time collision conditions may include a start time of DRX ON duration overlaps with the start time of ML activation time during its life cycle

$$( i . e . , {Ts}_{DRX}^{ON} = {Ts}_{ML}^{ON} ) .$$

In another example (i.e., unsynchronized case), the absolute value of time difference between the start time of DRX ON duration and the start time of ML activation time during its life cycle is less than a time threshold ε

$$( i . e . , \vert {Ts}_{DRX}^{ON} - {Ts}_{ML}^{ON} \vert \leq ε ) .$$

FIG. 2 illustrates both the above-mentioned synchronized case and unsynchronized case to evaluate the condition of whether the DRX cycle collides with ML life cycle in time domain.

$${Ts}_{DRX}^{ON}$$

denotes the start time or DRX cycle, and

$${Ts}_{ML}^{ON}$$

denotes the start time or ML life cycle. Only when this condition is true is a prioritization condition (discussed below) evaluated.

Following the MAC entity determining that the DRX cycle collides with the ML life cycle in time domain (e.g., ms or SFN) or overlapping in ε (ms or SFN), a MAC entity may evaluate monitoring conditions/criteria, and follow at least one of three cases, as follows.

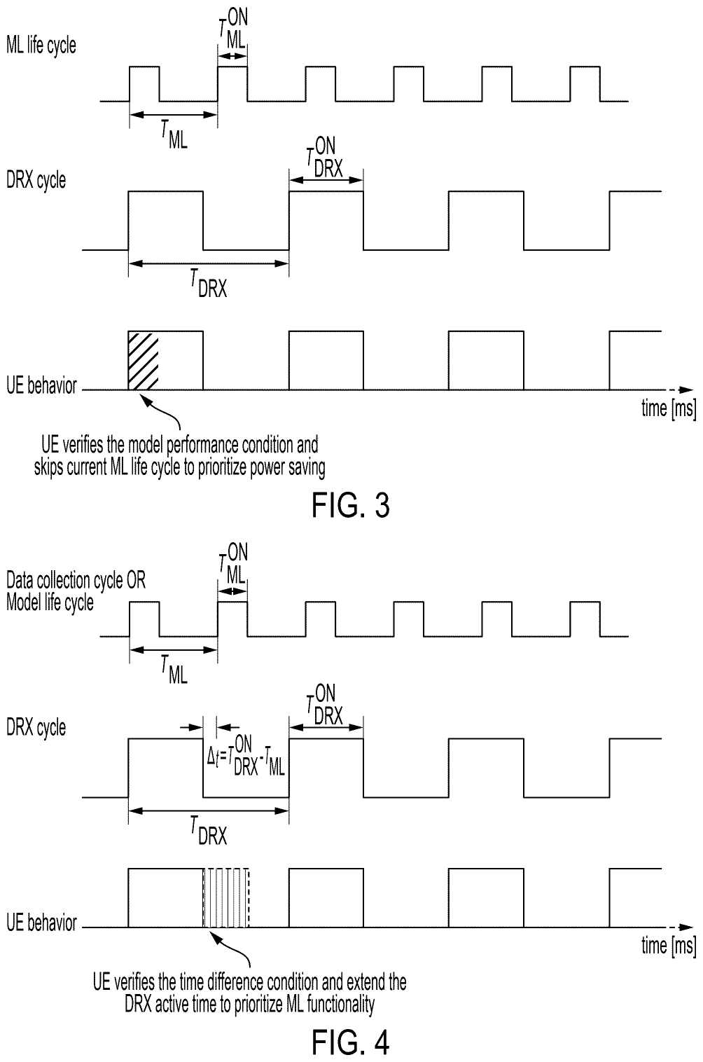

In case 1 (i.e., UE prioritizes power saving and DRX), the MAC entity may determine whether UE power saving is prioritized; if so, the ML life cycle may be skipped. In this case, the UE may prioritize the DRX to enhance the power saving performance by skipping the ML functionality if the current ML reliability level is high enough such that instance model re-training or monitoring procedure is unnecessary. FIG. 3 illustrates this case of the UE DRX cycle colliding with ML life cycle, wherein UE can skip the ML life cycle when the evaluation condition is fulfilled. In FIG. 3, the ML life cycle is represented as T_{ML} with the activation period

$${Ts}_{ML}^{ON} ,$$

and the DRX cycle is represented as T_{DRX} with the ON duration

$${Ts}_{DRX}^{ON} .$$

Various example embodiments of case 1 may include conditions to prioritize power saving (e.g., skip current ML life cycle), such as where the ML model shows a high reliability, eliminating the need for the next life cycle to collect data, perform retraining, monitor, etc. To maximize the power savings at the UE, the next ML life cycle may be skipped. The model reliability measurement may be higher than a preconfigured threshold, and may be based upon one or more conditions. For example, a model prediction accuracy/confidence may be applied when a supervised learning model is used for prediction; this condition may be qualified when model prediction accuracy or confidence is greater than a preconfigured threshold

$$( e . g . , {ϑ}_{thres}^{accuracy} ) .$$

Another example condition for case 1 includes an F-score (e.g., F-measure) for measuring a test's accuracy. An F-score may be calculated from the precision and recall of the test, where the precision is the number of true positive results divided by the number of all positive results, including those not identified correctly, and the recall is the number of true positive results divided by the number of all samples that should have been identified as positive. Precision may be known as a positive predictive value, and recall may be known as sensitivity in diagnostic binary classification. This condition may be applied when a supervised learning model is used for classification problems. The condition is qualified when the F-core is greater than a preconfigured threshold

$$( e . g . , {ϑ}_{thres}^{Fscore} ) .$$

A further example condition of case 1 includes a temporal difference (TD) error applied when a reinforcement learning model/algorithm is used. TD error may be characterized by the difference among the current learning samples and the former learning experience. The condition may be qualified when TD error is smaller than a preconfigured threshold

$$( e . g . , {ϑ}_{thres}^{TDe} ) .$$

Case 2 of the MAC entity evaluating monitoring conditions/criteria may include determining whether ML functionality is prioritized; if so, an extension of DRX active time may be triggered. FIG. 4 illustrates a UE DRX cycle colliding with ML life cycle firstly, and the UE extending the current DRX active time to prioritize the ML functionality when the evaluation condition is fulfilled. As shown in FIG. 4, the ML life cycle is represented as T_{ML} with the activation period

$${T}_{ML}^{ON} ,$$

and the DRX cycle is represented as T_{DRX} with the ON duration

$${T}_{DRX}^{ON} .$$

UE may prioritize the ML functionality when the upcoming ML life cycle is going to be activated after the end of the DRX ON duration. In this case, UE may extend the activation time of DRX ON duration so that data collection, model re-training or monitoring procedure within the extended active time. The extension would cover the upcoming ML life cycle.

Some example embodiments of case 2 may include conditions to prioritize ML functionality (e.g., ML-based extension of active time (ML-EAT)) when the absolute time difference between the end of DRX ON duration is very close to the upcoming ML life cycle. To prioritize the ML functionality in the next life cycle, the UE may extend the current DRX active time to cover at least the next ML life cycle. This may be based upon a condition of current DRX On duration vs adjacent ML life cycle for when the time difference between the end of current DRX ON duration and next ML life cycle is less than a preconfigured time threshold

$$( e . g . , {τ}_{thres}^{EAT} ) .$$

FIG. 4 illustrates an example of the condition holding true if

$${Δ}_{t} = {T}_{DRX}^{ON} - {T}_{ML} \leq {τ}_{thres}^{EAT} .$$

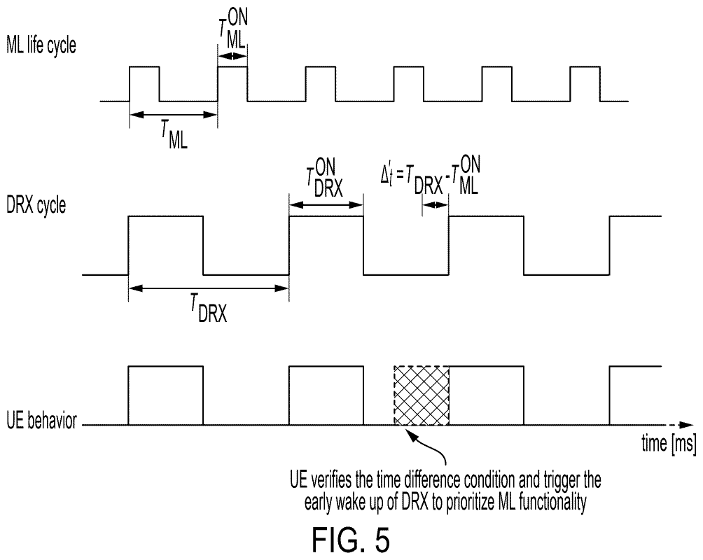

Case 3 of the MAC entity evaluating monitoring conditions/criteria may include determining whether ML functionality is prioritized; if so, an early wake-up signal for DRX may be triggered. In particular, the UE may prioritize the ML functionality when the UE needs to wake up the upcoming DRX ON duration so that the current ML life cycle is well covered within the active time in order to perform the data collection, model re-training, and/or monitoring. The early wake up of the next DRX ON duration shall cover the present ML life cycle. FIG. 5 illustrates when the UE DRX cycle collides with ML life cycle firstly, the UE can wake up the next DRX ON duration to prioritize the ML functionality when the evaluation condition is fulfilled. As shown, the ML life cycle is represented as T_{ML} with the activation period

$${T}_{ML}^{ON} ,$$

and the DRX cycle is represented as T_{DRX} with the ON duration

$${T}_{DRX}^{ON} .$$

Some example embodiments of case 3 may include conditions to prioritize ML functionality (with ML-based Wake-Up Signal (ML-WUS)) when the absolute time difference between the end of ML life cycle ON duration is very close to the upcoming DRX ON duration. To prioritize the ML functionality in the current life cycle, the UE may wake up the next DRX ON duration with WUS to cover the current ML life cycle. This may be based upon a condition of current ML life cycle vs adjacent DRX ON duration when the time difference between the end of current ML life cycle and the next DRX ON duration is less than a preconfigured time threshold

$${τ}_{thres}^{WUS} .$$

FIG. 5 shows an example that the condition is hold true if

$${Δ}_{t}^{′} = {T}_{DRX} - {T}_{ML}^{ON} \leq {τ}_{thres}^{WUS} .$$

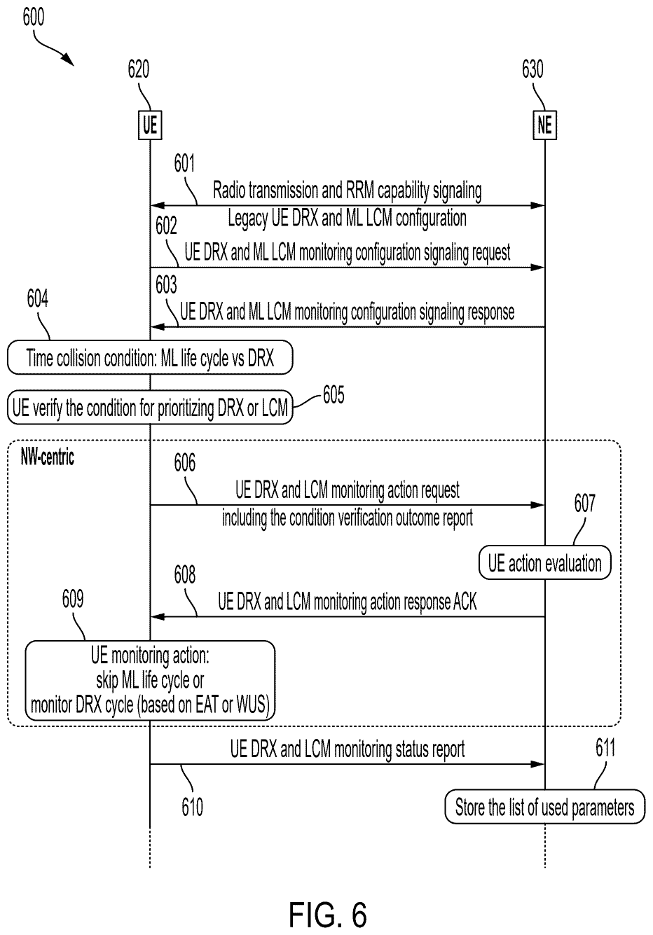

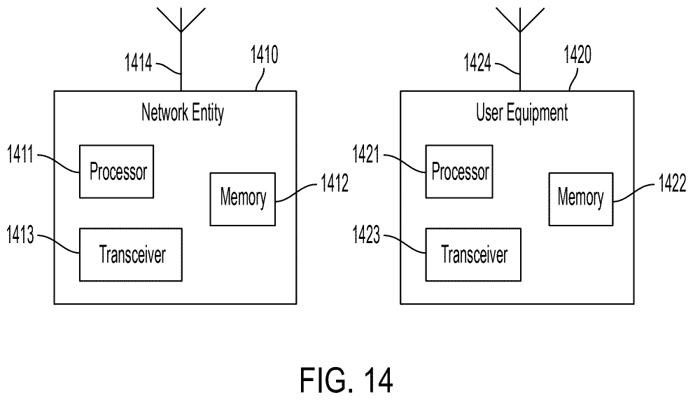

FIG. 6 illustrates an example of a signaling diagram 600 depicting an NW-centric embodiment where the UE always needs a NW grant before taking the action. UE 620 and NE 630 may be similar to UE 1420 and NE 1410, as illustrated in FIG. 14, according to certain example embodiments.

At operation 601, UE 620 and NE 630 may transmit capabilities to each other via RRC reconfiguration. Default parameters may be determined, including DRX configuration, ML LCM related configuration, etc.

At operation 602, UE 620 may transmit to NE 630 at least one DRX and LCM monitoring configuration signaling request to be used for the execution of DRX and ML LCM monitoring related procedures. This signaling request may be linked to UE capability information, which means UE 620 may request its supported/preferred configurations and criteria. Operation 602 may be performed simultaneously with operation 603 (discussed below) if UE capability information is not explicitly needed.

At operation 603, in response to the request received at operation 602, NE 630 may transmit to UE 620 at least one DRX and LCM monitoring configuration signaling response to be used for the execution of DRX and ML LCM monitoring related procedures. For example, the configuration signaling response may include at least one time collision condition between DRX and ML life cycle with related thresholds, such as 1) a start time of DRX ON duration overlaps with the start time of ML activation time during its life cycle

$$( {Ts}_{DRX}^{ON} = {Ts}_{ML}^{ON} )$$

(i.e., synchronized case); 2): an absolute value of time difference between the start time of DRX ON duration and the start time of ML activation time during its life cycle is less than a time threshold ε

$$( \vert {Ts}_{DRX}^{ON} - {Ts}_{ML}^{ON} \vert \leq ε )$$

(i.e., unsynchronized case); and/or 3) any other time constraints.

Additionally, the configuration signaling message may include at least one prioritization condition between DRX and ML life cycle with related thresholds, such as 1) prioritizing UE power saving including various ML reliability conditions such as

$$prediction accuracy / confidence vs {ϑ}_{thres}^{accuracy} , \\ F - score vs {ϑ}_{thres}^{Fscore} , and TD error vs {ϑ}_{thres}^{TDe} ( Case - 1 ) ; 2 )$$

prioritizing ML for a time condition for

$$ML - EAT vs {τ}_{thres}^{EAT} ( Case - 2 ) ;$$

and/or 3) prioritizing ML for time condition for

$$ML - WUS vs {τ}_{thres}^{WUS} ( Case - 3 ) .$$

Furthermore, the configuration signaling message may include other optional parameters, such as an evaluation time period/window T_{eval_DRX_ML} to execute the assessment of the above listed conditions.

At operation 604, upon receiving the RRC configuration, UE 620 may start to evaluate the time collision of ML life cycle and DRX. UE 620 may perform a time domain evaluation, and verify if the current DRX ON duration overlaps with the ML life cycle active time period, such as shown in FIG. 2. The constraints and thresholds may be configured at operation 603.

At operation 605, when the time collision condition holds true, UE 620 may start to evaluate the prioritization condition between power saving and ML functionality. For example, based upon the at least one DRX and LCM monitoring configuration signaling response, UE 620 may prioritize at least one of a DRX functionality or ML functionality. UE 620 may verify whether to prioritize power saving and DRX (Case-1) or ML (Case-2 and Case-3), as shown in FIGS. 3-5. Performance of operation 605 may be dependent on the time collision condition at operation 604 being verified.

In certain example embodiments, for AI/ML functionality identification and functionality-based LCM of UE-side models and/or UE-part of two-sided models, functionality may refer to an AI/ML-enabled feature/FG enabled by configuration(s), where configuration(s) is (are) supported based on conditions indicated by UE capability. Correspondingly, functionality-based LCM may operate based on, at least, one configuration of AI/ML-enabled Feature/FG or specific configurations of an AI/ML-enabled Feature/FG.

At operation 606, UE 620 may report to NE 630 the evaluation outcome of the configured conditions/criteria with the monitoring action request, such as a DRX and LCM monitoring action request with a condition verification outcome report. The reporting signal format may be formulated as a compound Q-bits that encodes the evaluation outcome of the pre-configured conditions. For example, a 2-bit indication may be used, where the first bit represents outcome of the time collision condition (e.g., 0: not collide, 1: collide), and the second bit represents the outcome of the prioritization option (e.g., 0: prioritize DRX, 1: prioritize ML). More bits may be generated for Q-bits information that also contains different UE monitoring actions. Depending on the timing constraints, this signal may be conveyed via the independent L1/L2 signaling channel, such as being embedded in MAC CE format.

In certain example embodiments, the DRX and LCM monitoring configuration signaling response may include one or more of: at least one time collision condition related parameter and at least one time collision condition related threshold; at least one ML LCM prioritization related parameter and at least one ML LCM prioritization related threshold; at least one UE DRX/power saving prioritization related parameter and at least one UE DRX/power saving prioritization related threshold; at least one UE feedback signal format; or at least one condition evaluation time period.

In various example embodiments, the condition verification outcome report may include at least one of: a first bit indicating a time collision condition; or a second bit indicating an outcome of the prioritizing. The first bit may include a first value indicating no collision, and a second value indicating a collision. The second bit may include a first value indicating prioritization of DRX, and a second value indicating prioritization of ML.

At operation 607, based upon the request from UE 620, NE 630 may decode the evaluation outcome information, and evaluate if the preferred monitoring actions should be granted.

At operation 608, NE 630 may transmit to UE 620 the response for the DRX and ML life cycle monitoring action request with the UE evaluation outcome report. When early wake up of DRX ON duration is preferred, this signaling can be ML-based WUS. When extension of active time is preferred, this signaling can be ML-based EAT indication. The signal format may be a simple 1-bit information via downlink control information (DCI), where 1 indicates ACK, and 0 indicates NACK.

At operation 609, UE 620 may perform a monitoring action as granted by NE 630 to either skip the ML life cycle for UE power saving, or monitor the DRX cycle to prioritize the ML functionality.

At operation 610, UE 620 may transmit to NE 630 the executed action from operation 609, and at operation 611, NE 630 may buffer historical UE actions/parameters for future usage. Operations 610 and/or 611 may be optional.

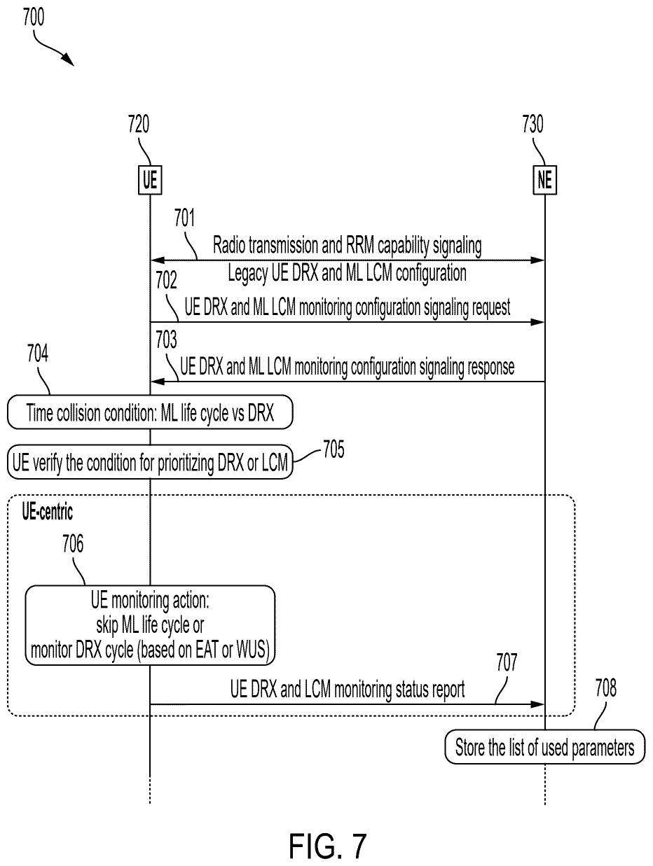

FIG. 7 illustrates an example of a signaling diagram 700 depicting a UE-centric embodiment for a UE dynamic solution without NW grant. UE 720 and NE 730 may be similar to UE 1420 and NE 1410, as illustrated in FIG. 14, according to certain example embodiments.

Operations 701-706 may be similar to operations 601-605 & 609 discussed above. At operation 707, UE 720 may transmit to NE 730 the DRX and ML life cycle monitoring status report after the action is performed, and may indicate an evaluation outcome of the configured conditions/criteria and the monitoring action. The reporting signal format is formulated as a compound Q-bits that encode the evaluation outcome of the pre-configured conditions. For example, a 2-bit indication may be used, where the first bit represents outcome of the time collision condition (e.g., 0: not collide, 1: collide), and the second bit represents the outcome of the prioritization option (e.g., 0: prioritize DRX, 1: prioritize ML). More digits may be generated for Q-bits information that also contains different UE monitoring actions. Depending on the timing constraints, this signal may be conveyed via the independent L1/L2 signaling channel, such as being embedded in MAC CE format.

In certain example embodiments, the DRX and LCM monitoring configuration signaling response may include one or more of: at least one time collision condition related parameter and at least one time collision condition related threshold; at least one ML LCM prioritization related parameter and at least one ML LCM prioritization related threshold; at least one UE DRX/power saving prioritization related parameter and at least one UE DRX/power saving prioritization related threshold; at least one UE feedback signal format; or at least one condition evaluation time period.

In various example embodiments, the condition verification outcome report may include at least one of: a first bit indicating a time collision condition; or a second bit indicating an outcome of the prioritizing. The first bit may include a first value indicating no collision, and a second value indicating a collision. The second bit may include a first value indicating prioritization of DRX, and a second value indicating prioritization of ML.

At operation 708, NE 730 may store the list of used parameters. Operation 708 may be optional.

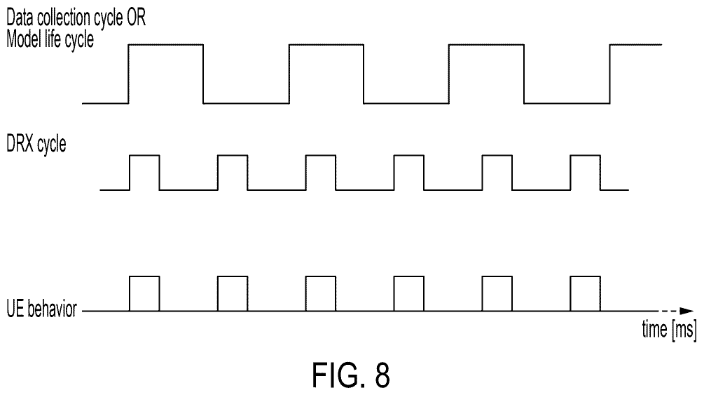

While the example embodiments above relate to DRX cycle being larger than ML life cycle, in various example embodiments, ML life cycle may be greater than DRX cycle so that all the possible overlapping cases can be included, as shown in FIG. 8.

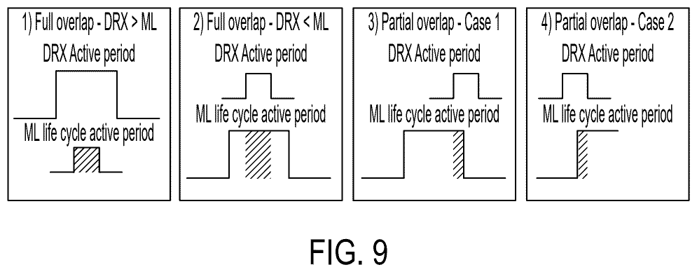

The above-mentioned cases are summarized and illustrated in FIG. 9, including 1) a full overlapping case when DRX active period can cover ML life cycle active period, where the UE may prioritize the ML functionalities without monitoring DRX on duration time, 2) a fully overlapping case when ML life cycle active period can cover DRX active period, where the UE may prioritize the ML functionalities by extending the current DRX on duration time with both early wake up signal and extension of active time, 3) a partial overlapping case when beginning of DRX active period overlaps with the end of ML life cycle active period, where the UE may prioritize the ML functionalities by early wake up the DRX on duration time, and 4) a partial overlapping case when the end of DRX active period overlaps with the beginning of ML life cycle active period, where the UE may prioritize the ML functionalities by using DRX extension of active time. If UE power saving is prioritized, DRX cycle may be skipped when ML reaches high performance or reliability.

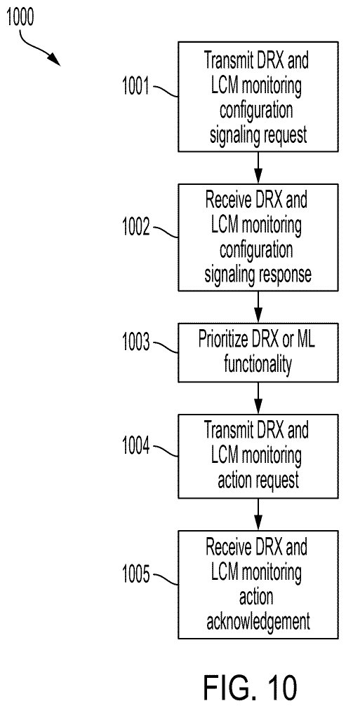

FIG. 10 illustrates an example of a flow diagram of a method 1000 that may be performed by a UE, such as UE 1420 illustrated in FIG. 14, according to certain example embodiments.

At step 1001, the method may include transmitting, from a UE to a network entity, at least one DRX and LCM monitoring configuration signaling request.

At step 1002, the method may further include receiving, by the UE, in response to the at least one DRX and LCM monitoring configuration signaling request, at least one DRX and LCM monitoring configuration signaling response from the network entity. In certain example embodiments, the at least one DRX and LCM monitoring configuration signaling response may include one or more of at least one time collision condition related parameter and at least one time collision condition related threshold; at least one ML LCM prioritization related parameter and at least one ML LCM prioritization related threshold; at least one UE, UE, DRX/power saving prioritization related parameter and at least one UE DRX prioritization related threshold; at least one UE feedback signal format; or at least one condition evaluation time period.

At step 1003, the method may further include prioritizing, by the UE, based on the at least one DRX and LCM monitoring configuration signaling response, at least one of a DRX functionality or a machine learning, ML, functionality.

At step 1004, the method may further include transmitting, from the UE to the network entity, a DRX and LCM monitoring action request, wherein the action request comprises a condition verification outcome report.

At step 1005, the method may further include receiving, by the UE, a DRX and LCM monitoring action acknowledgement from the network entity.

In certain example embodiments, the method may further include evaluating whether there is a time collision of ML LCM and DRX, based on one or more of the at least one time collision condition related parameter, or the at least one time collision condition related threshold.

In some example embodiments, the method may further include, in response to a result from the evaluating whether there is a time collision of ML LCM and DRX being positive, evaluating whether to prioritize the DRX functionality or the ML functionality, based on one or more of the at least one ML LCM prioritization related parameter and at least one ML LCM prioritization related threshold, or the at least one UE DRX/power saving prioritization related parameter and at least one UE DRX prioritization related threshold. The prioritizing the at least one of a DRX functionality or an ML functionality may be based on a result from the evaluating whether to prioritize the DRX functionality or the ML functionality.

In various example embodiments, the condition verification outcome report may be based, at least in part, on a result from the evaluating whether to prioritize the DRX functionality or the ML functionality.

In certain example embodiments, the condition verification outcome report may include at least one of a first bit indicating a time collision condition, or a second bit indicating an outcome of the prioritizing. The first bit may include a first value indicating no collision, and a second value indicating a collision. The second bit may include a first value indicating prioritization of the DRX functionality, and a second value indicating prioritization of the ML functionality.

In certain example embodiments, the method may further include performing, by the UE, at least one monitoring action indicated in the DRX and LCM monitoring action acknowledgement.

In some example embodiments, the method may further include receiving, from the network entity, capabilities of the UE via radio resource control reconfiguration.

In various example embodiments, the DRX and LCM monitoring action acknowledgement may be a wake-up signal, WUS, in response to early wake up of DRX ON duration being preferred.

In certain example embodiments, the DRX and LCM monitoring action acknowledgement may be an extension of active time, EAT, in response to EAT being preferred.

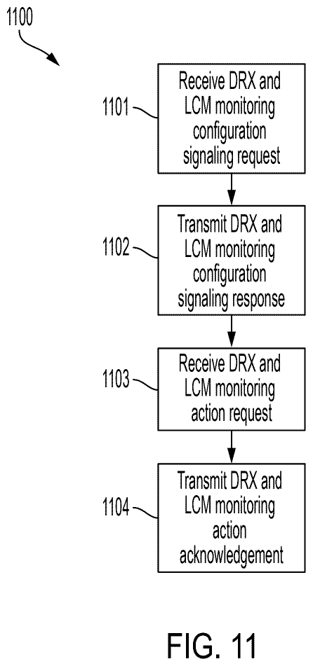

FIG. 11 illustrates an example of a flow diagram of a method 1100 that may be performed by a NE, such as NE 1410 illustrated in FIG. 14, according to some example embodiments.

At step 1101, the method may include receiving, by a network entity from a UE, at least one DRX and LCM monitoring configuration signaling request.

At step 1102, the method may further include transmitting, by the network entity to the UE, in response to the at least one DRX and LCM monitoring configuration signaling request, at least one DRX and LCM monitoring configuration signaling response.

At step 1103, the method may further include receiving, by the network entity from the UE, a DRX and LCM monitoring action request, wherein the action request comprises a condition verification outcome report.

At step 1104, the method may further include transmitting, by the network entity to the UE, a DRX and LCM monitoring action acknowledgement.

In certain example embodiments, the at least one DRX and LCM monitoring configuration signaling response comprises one or more of at least one time collision condition related parameter and at least one time collision condition related threshold; at least one ML LCM prioritization related parameter and at least one ML LCM prioritization related threshold; at least one UE, UE, DRX/power saving prioritization related parameter and at least one UE DRX prioritization related threshold; at least one UE feedback signal format; or at least one condition evaluation time period.

In some example embodiments, the DRX and LCM monitoring action acknowledgement may include a wake-up signal, WUS, in response to early wake up of DRX ON duration being preferred.

In various example embodiments, the DRX and LCM monitoring action acknowledgement may be an extension of active time, EAT, in response to EAT being preferred.

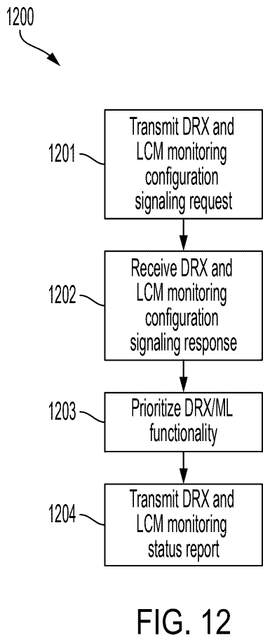

FIG. 12 illustrates an example of a flow diagram of a method 1200 that may be performed by a UE, such as UE 1420 illustrated in FIG. 14, according to various example embodiments.

At step 1201, the method may include transmitting, from a UE to a network entity, at least one DRX and LCM monitoring configuration signaling request.

At step 1202, the method may further include receiving, by the UE, in response to the at least one DRX and LCM monitoring configuration signaling request, at least one DRX and LCM monitoring configuration signaling response from the network entity.

At step 1203, the method may further include prioritizing, by the UE, based on the at least one DRX and LCM monitoring configuration signaling response, at least one of a DRX functionality or a machine learning, ML, functionality.

At step 1204, the method may further include transmitting, from the UE to the network entity, a DRX and LCM monitoring status report.

In certain example embodiments, the at least one DRX and LCM monitoring configuration signaling response may include one or more of at least one time collision condition related parameter and at least one time collision condition related threshold; at least one ML LCM prioritization related parameter and at least one ML LCM prioritization related threshold; at least one UE, UE, DRX/power saving prioritization related parameter and at least one UE DRX prioritization related threshold; at least one UE feedback signal format; or at least one condition evaluation time period.

In some example embodiments, the method may further include evaluating whether there is a time collision of ML LCM and DRX, based on one or more of: the at least one time collision condition related parameter; or the at least one time collision condition related threshold.

In various example embodiments, the method may further include, in response to a result from the evaluating whether there is a time collision of ML LCM and DRX being positive, evaluating whether to prioritize the DRX functionality or the ML functionality, based on one or more of the at least one ML LCM prioritization related parameter and at least one ML LCM prioritization related threshold, or the at least one UE DRX/power saving prioritization related parameter and at least one UE DRX prioritization related threshold. The prioritizing the at least one of a DRX functionality or an ML functionality may be based on a result from the evaluating whether to prioritize the DRX functionality or the ML functionality.

In certain example embodiments, the condition verification outcome report may be based, at least in part, on a result from the evaluating whether to prioritize the DRX functionality or the ML functionality. The condition verification outcome report may at least one of a first bit indicating a time collision condition; or a second bit indicating an outcome of the prioritizing. The first bit may include a first value indicating no collision, and a second value indicating a collision. The second bit may include a first value indicating prioritization of the DRX functionality, and a second value indicating prioritization of the ML functionality.

In some example embodiments, the method may further include receiving, from the network entity, capabilities of the UE via radio resource control reconfiguration.

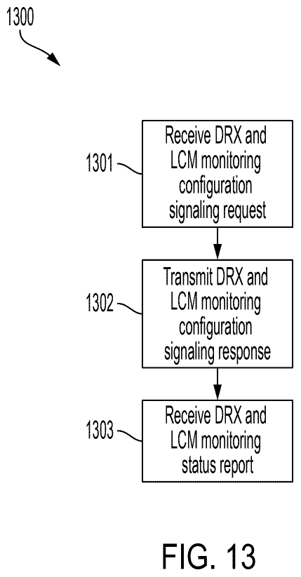

FIG. 13 illustrates an example of a flow diagram of a method 1300 that may be performed by a NE, such as NE 1410 illustrated in FIG. 14, according to certain example embodiments.

At step 1301, the method may include receiving, by a network entity from a UE, at least one DRX and LCM monitoring configuration signaling request.

At step 1302, the method may further include transmitting, by the network entity to the UE, in response to the at least one DRX and LCM monitoring configuration signaling request, at least one DRX and LCM monitoring configuration signaling response.

At step 1303, the method may further include receiving, by the network entity from the UE, a DRX and LCM monitoring status report.

In certain example embodiments, the at least one DRX and LCM monitoring configuration signaling response may include one or more of at least one time collision condition related parameter and at least one time collision condition related threshold; at least one ML LCM prioritization related parameter and at least one ML LCM prioritization related threshold; at least one UE DRX/power saving prioritization related parameter and at least one UE DRX prioritization related threshold; at least one UE feedback signal format; or at least one condition evaluation time period.

FIG. 14 illustrates an example of a system according to certain example embodiments. In one example embodiment, a system may include multiple devices, such as, for example, NE 1410 and/or UE 1420.

NE 1410 may be one or more of a base station (e.g., 3G UMTS NodeB, 4G LTE Evolved NodeB, or 5G NR Next Generation NodeB), a serving gateway, a server, and/or any other access node or combination thereof.

NE 1410 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 1420 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1410 and/or UE 1420 may be one or more of a citizens broadband radio service device (CBSD).

NE 1410 and/or UE 1420 may include at least one processor, respectively indicated as 1411 and 1421. Processors 1411 and 1421 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1412 and 1422. The memory may be fixed or removable. The memory may include computer program instructions or computer code contained therein. Memories 1412 and 1422 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1411 and 1421, memories 1412 and 1422, and any subset thereof, may be configured to provide means corresponding to the various blocks of FIGS. 1-13. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 14, transceivers 1413 and 1423 may be provided, and one or more devices may also include at least one antenna, respectively illustrated as 1414 and 1424. The device may have many antennas, such as an array of antennas configured for multiple input multiple output (MIMO) communications, or multiple antennas for multiple RATs. Other configurations of these devices, for example, may be provided. Transceivers 1413 and 1423 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-13). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-13. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

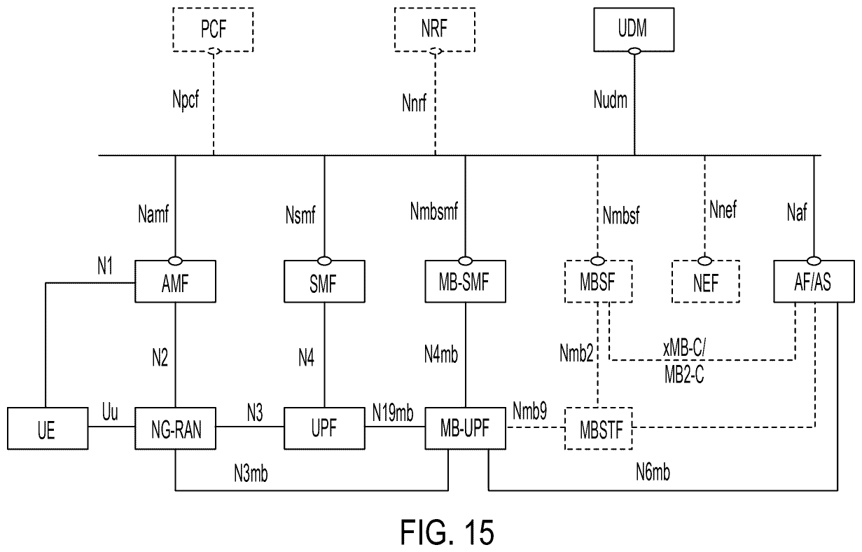

FIG. 15 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 15 may be similar to NE 1410 and UE 1420, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 1411 and 1421, and memories 1412 and 1422, may be included in or may form a part of processing circuitry or control circuitry. In addition, in some example embodiments, transceivers 1413 and 1423 may be included in or may form a part of transceiving circuitry.

In some example embodiments, an apparatus (e.g., NE 1410 and/or UE 1420) may include means for performing a method, a process, or any of the variants discussed herein. Examples of the means may include one or more processors, memory, controllers, transmitters, receivers, and/or computer program code for causing the performance of the operations.

In various example embodiments, apparatus 1420 may be controlled by memory 1422 and processor 1421 to transmit, to a network entity, at least one discontinuous reception, DRX, and life cycle management, LCM, monitoring configuration signaling request; receive, in response to the at least one DRX and LCM monitoring configuration signaling request, at least one DRX and LCM monitoring configuration signaling response from the network entity; prioritize, based on the at least one DRX and LCM monitoring configuration signaling response, at least one of a DRX functionality or a machine learning, ML, functionality; transmit, to the network entity, a DRX and LCM monitoring action request, wherein the action request comprises a condition verification outcome report; and receive a DRX and LCM monitoring action acknowledgement from the network entity.

Certain example embodiments may be directed to an apparatus that includes means for performing any of the methods described herein including, for example, means for transmitting, to a network entity, at least one discontinuous reception, DRX, and life cycle management, LCM, monitoring configuration signaling request; means for receiving, in response to the at least one DRX and LCM monitoring configuration signaling request, at least one DRX and LCM monitoring configuration signaling response from the network entity; means for prioritizing, based on the at least one DRX and LCM monitoring configuration signaling response, at least one of a DRX functionality or a machine learning, ML, functionality; means for transmitting, to the network entity, a DRX and LCM monitoring action request, wherein the action request comprises a condition verification outcome report; and means for receiving a DRX and LCM monitoring action acknowledgement from the network entity.

In various example embodiments, apparatus 1410 may be controlled by memory 1412 and processor 1411 to receive, from a user equipment, at least one discontinuous reception, DRX, and life cycle management, LCM, monitoring configuration signaling request; transmit, to the user equipment, in response to the at least one DRX and LCM monitoring configuration signaling request, at least one DRX and LCM monitoring configuration signaling response; receive, from the user equipment, a DRX and LCM monitoring action request, wherein the action request comprises a condition verification outcome report; and transmit, to the user equipment, a DRX and LCM monitoring action acknowledgement.

Certain example embodiments may be directed to an apparatus that includes means for performing any of the methods described herein including, for example, means for receiving, from a user equipment, at least one discontinuous reception, DRX, and life cycle management, LCM, monitoring configuration signaling request; means for transmitting, to the user equipment, in response to the at least one DRX and LCM monitoring configuration signaling request, at least one DRX and LCM monitoring configuration signaling response; means for receiving, from the user equipment, a DRX and LCM monitoring action request, wherein the action request comprises a condition verification outcome report; and means for transmitting, to the user equipment, a DRX and LCM monitoring action acknowledgement.

In various example embodiments, apparatus 1420 may be controlled by memory 1422 and processor 1421 to transmit, to a network entity, at least one discontinuous reception, DRX, and life cycle management, LCM, monitoring configuration signaling request; receive, in response to the at least one DRX and LCM monitoring configuration signaling request, at least one DRX and LCM monitoring configuration signaling response from the network entity; prioritize, based on the at least one DRX and LCM monitoring configuration signaling response, at least one of a DRX functionality or a machine learning, ML, functionality; and transmit, to the network entity, a DRX and LCM monitoring status report.

Certain example embodiments may be directed to an apparatus that includes means for performing any of the methods described herein including, for example, means for transmitting, to a network entity, at least one discontinuous reception, DRX, and life cycle management, LCM, monitoring configuration signaling request; means for receiving, in response to the at least one DRX and LCM monitoring configuration signaling request, at least one DRX and LCM monitoring configuration signaling response from the network entity; means for prioritizing, based on the at least one DRX and LCM monitoring configuration signaling response, at least one of a DRX functionality or a machine learning, ML, functionality; and means for transmitting, to the network entity, a DRX and LCM monitoring status report.

In various example embodiments, apparatus 1410 may be controlled by memory 1412 and processor 1411 to receive, from a user equipment, at least one discontinuous reception, DRX, and life cycle management, LCM, monitoring configuration signaling request; transmit, to the user equipment, in response to the at least one DRX and LCM monitoring configuration signaling request, at least one DRX and LCM monitoring configuration signaling response; and receive, from the user equipment, a DRX and LCM monitoring status report.

Certain example embodiments may be directed to an apparatus that includes means for performing any of the methods described herein including, for example, means for receiving, from a user equipment, at least one discontinuous reception, DRX, and life cycle management, LCM, monitoring configuration signaling request; means for transmitting, to the user equipment, in response to the at least one DRX and LCM monitoring configuration signaling request, at least one DRX and LCM monitoring configuration signaling response; and means for receiving, from the user equipment, a DRX and LCM monitoring status report.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP 3^{rd} Generation Partnership Project
5G 5^{th} Generation
5GC 5^{th} Generation Core
6G 6^{th} Generation
AF Application Function
ASIC Application Specific Integrated Circuit
CBSD Citizens Broadband Radio Service Device
CE Control Element
CPU Central Processing Unit
CSI Channel State Information
CU Centralized Unit
DCP Downlink Control Information of Power Saving
DL Downlink
DRX Discontinuous Reception
DU Distributed Unit
EAT Extension of Active Time
eMBB Enhanced Mobile Broadband
eNB Evolved Node B
gNB Next Generation Node B
GPS Global Positioning System
HARQ Hybrid Automatic Repeat Request
HDD Hard Disk Drive
HO Handover
HOF Handover Failure
ID Identifier
IoT Internet of Things
KPI Key Performance Indicator
L1 Layer 1
L2 Layer 2
LCM Life Cycle Management
LTE Long-Term Evolution
LTE-A Long-Term Evolution Advanced
MAC Medium Access Control
MEMS Micro Electrical Mechanical System
MIMO Multiple Input Multiple Output
ML Machine Learning
mMTC Massive Machine Type Communication
ms Millisecond
NE Network Entity
NG Next Generation
NG-eNB Next Generation Evolved Node B
NG-RAN Next Generation Radio Access Network
NR New Radio
NW Network
Pcell Primary Cell
PDA Personal Digital Assistance
PDCCH Physical Downlink Control Channel
PUCCH Physical Uplink Control Channel
QoS Quality of Service
RAM Random Access Memory
RAN Radio Access Network
RAT Radio Access Technology
RF Radio Frequency
RLF Radio Link Failure
ROM Read-Only Memory
RRC Radio Resource Control
RRM Radio Resource Management
RSRP Reference Signal Received Power
SFN System Frame Number
TD Temporal Difference
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WUS Wake Up Signal

1. An apparatus comprising:
at least one processor; and
at least one memory storing instructions that, when executed by the at least one processor, cause the apparatus at least to:
transmit, to a network entity, at least one discontinuous reception, DRX, and life cycle management, LCM, monitoring configuration signaling request;
receive, in response to the at least one DRX and LCM monitoring configuration signaling request, at least one DRX and LCM monitoring configuration signaling response from the network entity;
prioritize, based on the at least one DRX and LCM monitoring configuration signaling response, at least one of a DRX functionality or a machine learning, ML, functionality; and
transmit, to the network entity, a DRX and LCM monitoring status report.

2. The apparatus of claim 1, wherein the at least one DRX and LCM monitoring configuration signaling response comprises one or more of:
at least one time collision condition related parameter and at least one time collision condition related threshold;
at least one ML LCM prioritization related parameter and at least one ML LCM prioritization related threshold;
at least one user equipment, UE, DRX prioritization related parameter and at least one UE DRX prioritization related threshold;
at least one UE feedback signal format; or
at least one condition evaluation time period.

3. The apparatus of claim 2, wherein the at least one memory and the instructions, when executed by the at least one processor, further cause the apparatus at least to:
evaluate whether there is a time collision of ML LCM and DRX, based on one or more of:
the at least one time collision condition related parameter; or
the at least one time collision condition related threshold.

4. The apparatus of claim 3, wherein the at least one memory and the instructions, when executed by the at least one processor, further cause the apparatus at least to:
in response to a result from the evaluating whether there is a time collision of ML LCM and DRX being positive, evaluate whether to prioritize the DRX functionality or the ML functionality, based on one or more of:
the at least one ML LCM prioritization related parameter and at least one ML LCM prioritization related threshold, or
the at least one UE DRX prioritization related parameter and at least one UE DRX prioritization related threshold,
wherein the prioritizing the at least one of a DRX functionality or an ML functionality is based on a result from the evaluating whether to prioritize the DRX functionality or the ML functionality.

5. The apparatus of claim 1, wherein the condition verification outcome report is based, at least in part, on a result from the evaluating whether to prioritize the DRX functionality or the ML functionality.

6. The method of claim 1, wherein the condition verification outcome report comprises at least one of:
a first bit indicating a time collision condition; or
a second bit indicating an outcome of the prioritizing.

7. The apparatus of claim 6, wherein the first bit comprises a first value indicating no collision, and a second value indicating a collision.

8. The apparatus of claim 6, wherein the second bit comprises a first value indicating prioritization of the DRX functionality, and a second value indicating prioritization of the ML functionality.

9. The apparatus of claim 1, wherein the at least one memory and the instructions, when executed by the at least one processor, further cause the apparatus at least to:
receive, from the network entity, capabilities of the user equipment via radio resource control reconfiguration.

10. An apparatus comprising:
at least one processor; and
at least one memory storing instructions that, when executed by the at least one processor, cause the apparatus at least to:
receive, from a user equipment, at least one discontinuous reception, DRX, and life cycle management, LCM, monitoring configuration signaling request;
transmit, to the user equipment, in response to the at least one DRX and LCM monitoring configuration signaling request, at least one DRX and LCM monitoring configuration signaling response; and
receive, from the user equipment, a DRX and LCM monitoring status report.

11. The apparatus of claim 10, wherein the at least one DRX and LCM monitoring configuration signaling response comprises one or more of:
at least one time collision condition related parameter and at least one time collision condition related threshold;
at least one ML LCM prioritization related parameter and at least one ML LCM prioritization related threshold;
at least one user equipment, UE, DRX prioritization related parameter and at least one UE DRX prioritization related threshold;
at least one UE feedback signal format; or
at least one condition evaluation time period.

12. A method comprising:
transmitting, from a user equipment to a network entity, at least one discontinuous reception, DRX, and life cycle management, LCM, monitoring configuration signaling request;
receiving, by the user equipment, in response to the at least one DRX and LCM monitoring configuration signaling request, at least one DRX and LCM monitoring configuration signaling response from the network entity;
prioritizing, by the user equipment, based on the at least one DRX and LCM monitoring configuration signaling response, at least one of a DRX functionality or a machine learning, ML, functionality; and
transmitting, from the user equipment to the network entity, a DRX and LCM monitoring status report.

13. The method of claim 12, wherein the at least one DRX and LCM monitoring configuration signaling response comprises one or more of:
at least one time collision condition related parameter and at least one time collision condition related threshold;
at least one ML LCM prioritization related parameter and at least one ML LCM prioritization related threshold;
at least one user equipment, UE, DRX prioritization related parameter and at least one UE DRX prioritization related threshold;
at least one UE feedback signal format; or
at least one condition evaluation time period.

14. The method of claim 13, further comprising:
evaluating whether there is a time collision of ML LCM and DRX, based on one or more of:
the at least one time collision condition related parameter; or
the at least one time collision condition related threshold.

15. The method of claim 14, further comprising:
in response to a result from the evaluating whether there is a time collision of ML LCM and DRX being positive, evaluating whether to prioritize the DRX functionality or the ML functionality, based on one or more of:
the at least one ML LCM prioritization related parameter and at least one ML LCM prioritization related threshold, or
the at least one UE DRX prioritization related parameter and at least one UE DRX prioritization related threshold,
wherein the prioritizing the at least one of a DRX functionality or an ML functionality is based on a result from the evaluating whether to prioritize the DRX functionality or the ML functionality.

16. The method of claim 12, wherein the condition verification outcome report is based, at least in part, on a result from the evaluating whether to prioritize the DRX functionality or the ML functionality.

17. The method of claim 12, wherein the condition verification outcome report comprises at least one of:
a first bit indicating a time collision condition; or
a second bit indicating an outcome of the prioritizing.

18. The method of claim 17, wherein the first bit comprises a first value indicating no collision, and a second value indicating a collision.

19. The method of claim 17, wherein the second bit comprises a first value indicating prioritization of the DRX functionality, and a second value indicating prioritization of the ML functionality.

20. The method of claim 12, further comprising:
receiving, from the network entity, capabilities of the user equipment via radio resource control reconfiguration.

21-28. (canceled)
